(19) United States
(12) Patent Application Publication
(10) Pub. No.: US 2002/0087409 A1
(43) Pub. Date: Jul. 4, 2002

(54) Apparatus and method for providing marketing, advertising, and/or promotional, materials with account billing and/or account statement information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/032,458

(22) Filed: Jan. 2, 2002

Related U.S. Application Data
(60) Provisional application No. 60/259,476, filed on Jan. 3, 2001.

(51) Int. Cl. G06F 17/60

(52) U.S. Cl. 705/14

(57) ABSTRACT

An apparatus and method for providing marketing, advertising, or promotional, information along with an account bill, statement, or correspondence, including a memory device for storing at least one of account information, billing information, statement information, marketing information, advertising information, and promotional information, a processor for detecting the generation of a respective bill, statement, or correspondence, wherein the processor at least one of identifies and selects the materials to be provided with the respective bill, statement, or correspondence, and further wherein the processor generates the materials, and at least one of an output device, for outputting and a transmitter for transmitting the materials, to a communication device associated with an account holder.

### RELATED APPLICATIONS

This application claims the benefit of priority of U.S. Provisional Patent Application Serial No. 60/259,476, filed Jan. 3, 2001, and entitled “APPARATUS AND METHOD FOR PROVIDING MARKETING, ADVERTISING, AND/OR PROMOTIONAL, MATERIALS WITH ACCOUNT BILLING AND/OR ACCOUNT STATEMENT INFORMATION”, the subject matter of which is hereby incorporated by reference herein.

### FIELD OF THE INVENTION

The present invention pertains to an apparatus and method for providing marketing, advertisement, and/or promotional, materials with account billing and/or account statement information and, in particular, to an apparatus and method for providing marketing, advertisement, and/or promotional, materials with account billing and/or account statement information for credit card accounts, credit accounts, debit accounts, bank accounts, checking accounts, electronic money accounts, utility accounts, services accounts, subscription accounts, and/or any other accounts involving providing correspondence to account holders.

### BACKGROUND OF THE INVENTION

The practice and business of direct marketing continues to be a popular and an effective way in which businesses, entities and individuals can market, advertise, and/or promote, goods, products, services, information, and subscriptions for same. The practice of direct mail marketing has also grown to be a very popular and often utilized direct marketing practice.

The practice of providing marketing, advertising and/or promotional, materials and/or information along with credit card billing statements which are mailed to account holders has also become a popular practice. The inclusion of marketing, advertising and/or promotional, materials and/or information in credit card account statements can prove to be more effective in obtaining an individual's attention than conventional “junk” mail.

The prior art practice of providing marketing, advertising and/or promotional, materials and/or information along with credit card billing statements, however, has many drawbacks. The materials, typically in hard copy form, are typically standardized materials which can be provided in conjunction with the marketing, advertising and/or promotional, activities or efforts of a single merchant or a particular group of merchants.

The prior art systems fail to provide an apparatus and method which can provide marketing, advertising, and/or promotional, materials or information which can be generated in conjunction with the generation of account bills, account statements, account billing statements, and/or other account-related communications or correspondence.

The prior art systems also fail to provide marketing, advertising, and/or promotional, materials or information which can be provided along with account bills, account statements, account billing statements, and/or other account-related communications or correspondence, which can be pre-selected by a merchant or advertiser, or which can be requested by an account holder or account owner.

The prior art systems also fail to provide for the generation of, and/or the dissemination of, marketing, advertising, and/or promotional, materials or information along with account bills, account statements, account billing statements, and/or other account-related communications or correspondence, in hard copy form or in electronic form.

### SUMMARY OF THE PRESENT INVENTION

The present invention pertains to an apparatus and method for providing marketing, advertisement, and/or promotional, materials with account billing and/or account statement information which overcomes the shortfalls of the prior art.

The present invention pertains to an apparatus and method for providing marketing, advertisement, and/or promotional, materials with account billing and/or account statement information for credit card accounts, credit accounts, debit accounts, bank accounts, checking accounts, electronic money accounts, utility accounts, services accounts, subscription accounts, and/or any other accounts involving providing correspondence to account holders.

The apparatus and method of the present invention can provide marketing, advertisement, and/or promotional, materials and/or information, along with and/or in conjunction with, account billing information, account bills, account billing correspondence, account statement information, account statements, and/or account statement correspondence. The apparatus and method of the present invention can provide marketing, advertisement, and/or promotional, materials and/or information, in hardcopy form, in electronic form, and/or in any combination of same.

The apparatus and method of the present invention can also provide marketing, advertisement, and/or promotional, materials and/or information, which can be pre-selected for an account or account holder and/or which can be custom-tailored and/or custom-selected for a particular account or account holder based upon information regarding a particular account, a particular account holder, and/or a particular merchant, advertiser, promoter, and/or any provider of any goods, products, and/or services.

The apparatus of the present invention includes a central processing computer which can perform processing routines and/or processing operations for providing marketing materials and/or information, advertising materials and/or information, or promotional materials and/or information, along with and/or in conjunction with account billing information or correspondence, or account statement information or correspondence.

The apparatus of the present invention can also include one of more merchant computers which can be associated with can one or more of merchants, vendors, or providers, of any goods, products, or services, which can be the subject to commerce.

The apparatus of the present invention can also include one of more advertiser computers which can be associated with can one or more of merchants, vendors, or providers, of any goods, products, or services, advertisers, and/or promoters, who or which can provide and/or be responsible for providing and/or causing to be provided any of the marketing materials and/or information, advertising materials and/or information, and/or promotional materials and/or information.

The apparatus of the present invention can also include one of more user communication device which can be associated with can one or more of the herein-described users or individuals.

The present invention can be utilized on, over, and/or in conjunction with, any suitable communication network or system, including, but not limited to the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

The present invention can be utilized in order to provide marketing materials or information, advertising materials or information, promotional materials or information, and/or offering materials or information, for or regarding any goods, products, services, information, subscriptions, and/or subscriptions for any of the above goods, products, services, and/or information, of any kind or type, along with and/or in conjunction with and/or with any account bills, account correspondence, account billing correspondence, account billing statements, account statements, account statement correspondence, and/or any other account-related communication and/or correspondence.

The respective marketing materials or information, advertising materials or information, promotional materials or information, and/or offering materials or information, as well as the associated, corresponding, and/or underlying account bills, account correspondence, account billing correspondence, account billing statements, account statements, account statement correspondence, and/or any other account-related communication and/or correspondence, can be generated, produced and sent, transmitted, and/or disseminated in hard copy form, such as in the form of hardcopy printed bills, statements, communications, correspondence, marketing materials, advertisement materials, and/or promotional material, which can be sent via physical delivery, and/or can be generated, produced and sent, transmitted, and/or disseminated in electronic form, such as in the form of electronic bills, statements, communications, correspondence, marketing materials, advertisement materials, and/or promotional material, which can be sent via electronic transmission, facsimile transmission, electronic mail (e-mail) message transmission, instant messaging message transmission, and/or via any other electronic or digital transmission.

The present invention can await and/or detect the generation of any one or more an account bill, an account correspondence, an account billing correspondence, an account billing statement, an account statement, an account statement correspondence, and/or any other account-related communication and/or correspondence, for a particular account.

The present invention can also generate and/or produce the respective account bill, account correspondence, account billing correspondence, account billing statement, account statement, account statement correspondence, and/or any other account-related communication and/or correspondence, and either print same out in hard copy form and/or store same in electronic form.

The present invention can also identify the respective marketing materials or information, advertising materials or information, and/or promotional materials or information, which are to be provided with, or in conjunction with, the respective account bill, account correspondence, account billing correspondence, account billing statement, account statement, account statement correspondence, and/or any other account-related communication and/or correspondence, for the particular account.

The present invention can generate or produce the respective marketing materials or information, advertising materials or information, and/or promotional materials or information. The respective marketing materials or information, advertising materials or information, and/or promotional materials or information, can be generated in hard copy form, such as by printing the respective materials or information out on a printer, or in electronic form.

The present invention can output or produce hard copies of the account bill(s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, can correlate same, can processed same for physical delivery or physical mail delivery to the respective user(s), individual(s), account holder(s), and/or account owner(s), and can facilitate the physical delivery of same.

The present invention can also provide the respective account bill (s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, with identification and/or tracking information for tracking the use and/or effectiveness of the respective marketing materials or information, advertising materials or information, and/or promotional materials or information.

The present invention can also process transactions involving, orders for, and/or purchases and/or leases for, any goods, products, services, information, and/or subscriptions, which can be the subject of any of the respective marketing materials or information, advertising materials or information, and/or promotional materials or information.

The present invention can also process financial transactions, and/or effect electronic financial transfers, including electronic funds transfers, for, on behalf of and/or for, any of the respective users, individuals, account holders, account owners, merchants, providers, vendors, marketers, advertisers, and/or promoters, and/or agents of same. The present invention can also process a transaction and/or a financial transaction for facilitating a payment by a merchant to a marketer or advertiser such as in an agency relationship, a broker relationship, a finder's fee-based relationship, and/or an affiliated marketing relationship.

The respective marketing materials or information, advertising materials or information, promotional materials or information, and/or offering materials or information, as well as the associated, corresponding, and/or underlying account bills, account correspondence, account billing correspondence, account billing statements, account statements, account statement correspondence, and/or any other account-related communication and/or correspondence, can be generated, produced and sent, transmitted, and/or disseminated in electronic form.

The respective marketing materials or information, advertising materials or information, and/or promotional materials or information, can contain links or hyperlinks to any of the merchants, providers, vendors, marketers, advertisers, and/or promoters, and/or can contain links and/or hyperlinks to any information pertaining to any of the goods, products, services, information, magazines, periodicals, and/or other entities which are being featured in, and/or which are being marketed, advertised, and/or promoted, in or by the respective marketing materials or information, advertising materials or information, and/or promotional materials or information.

The respective account bill(s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, can be generated as any one or more of e-mail messages, instant messaging messages, facsimile messages, electronic messages and/or electronic transmission messages.

The present invention can also process transactions involving orders for, and/or purchases and/or leases for, any of the goods, products, services, information, and/or subscriptions, which can be the subject of any of the respective marketing materials or information, advertising materials or information, and/or promotional materials or information.

The present invention can also process financial transactions, and/or effect electronic financial transfers, including electronic funds transfers, for, on behalf of and/or for, any of the respective users, individuals, account holders, account owners, merchants, providers, vendors, marketers, advertisers, and/or promoters, and/or agents of same. The present invention can also process a transaction and a financial transaction for facilitating a payment by a merchant to a marketer or advertiser such as in an agency relationship, a broker relationship, a finder's fee-based relationship, and/or an affiliated marketing relationship.

The present invention can be utilized in order to market, advertise, promote, sell or lease, any goods, products, services, information, magazines, periodicals, newspapers, newsletters, which can be the subject of commerce and/or of a transaction, and/or can be utilized in order to market, advertise, promote, sell or lease, subscriptions for any of the above-described goods, products, services, information, magazines, periodicals, newspapers, newsletters.

The present invention can also provide notification of the scheduled sending, transmission, and/or dissemination, and/or of the actual sending, transmission, and/or dissemination, of any of the herein-described account bills, account correspondences, account billing correspondences, account billing statements, account statements, account statement correspondences, and/or any other account-related communications and/or correspondences, and the respective marketing materials or information, advertising materials or information, and/or promotional materials or information.

The present invention can also be utilized in order to disseminate sales or clearance offerings for any of the herein-described goods, products, services, information, magazines, periodicals, newspapers, newsletters, and/or subscriptions for any of the above-described goods, products, services, information, magazines, periodicals, newspapers, newsletters.

The apparatus and method of the present invention can be utilized in order to facilitate repeat transactions between any of the herein-described users, individuals, account holders, accounts owners, merchants, providers and vendors. The present invention can also be utilized in order to build customer loyalty.

The present invention can also be utilized in order to develop the branding of goods, products, and services, as well as co-branding relationships between respective parties or entities.

Accordingly, it is an object of the present invention to provide an apparatus and method for providing marketing, advertisement, and/or promotional, materials along with, or in conjunction with, account billing and/or account statement information.

It is another object of the present invention to provide an apparatus and method for providing marketing, advertisement, and/or promotional, materials with account billing and/or account statement information for credit card accounts, credit accounts, debit accounts, bank accounts, checking accounts, electronic money accounts, utility accounts, services accounts, subscription accounts, and/or any other accounts involving providing correspondence to account holders.

It is still another object of the present invention to provide an apparatus and method which can provide marketing, advertisement, and/or promotional, materials and/or information, in hard copy form, along with and/or in conjunction with, account billing information, account bills, account billing correspondence, account statement information, account statements, and/or account statement correspondence.

It is yet another object of the present invention to provide an apparatus and method which can provide marketing, advertisement, and/or promotional, materials and/or information, in electronic form, along with and/or in conjunction with, account billing information, account bills, account billing correspondence, account statement information, account statements, and/or account statement correspondence.

It is another object of the present invention to provide an apparatus and method for providing marketing, advertisement, and/or promotional, materials along with, or in conjunction with, account billing and/or account statement information which can pre-select, custom-tailor, and/or custom-select the marketing, advertisement, and/or promotional, materials for a particular account or account holder.

It is still another object of the present invention to provide an apparatus and method for providing marketing, advertisement, and/or promotional, materials along with, or in conjunction with, account billing and/or account statement information which can be utilized on, over, and/or in conjunction with, any suitable communication network or system.

It is yet another object of the present invention to provide an apparatus and method for providing marketing, advertisement, and/or promotional, materials along with, or in conjunction with, account billing and/or account statement information which can be utilized on, over, and/or in conjunction with, the Internet and/or the World Wide Web.

It is another object of the present invention to provide an apparatus and method for providing marketing, advertisement, and/or promotional, materials along with, or in conjunction with, account billing and/or account statement information which can be utilized on, over, and/or in conjunction with, any suitable wireless communication network or system.

It is still another object of the present invention to provide an apparatus and method for providing marketing, advertisement, and/or promotional, materials along with, or in conjunction with, account billing and/or account statement information which can detect the generation of any one or more an account bill, an account correspondence, an account billing correspondence, an account billing statement, an account statement, an account statement correspondence, and/or any other account-related communication and/or correspondence.

It is yet another object of the present invention to provide an apparatus and method for providing marketing, advertisement, and/or promotional, materials along with, or in conjunction with, account billing and/or account statement information which can generate and/or produce an account bill, an account correspondence, an account billing correspondence, an account billing statement, an account statement, an account statement correspondence, and/or any other account-related communication and/or correspondence.

It is another object of the present invention to provide an apparatus and method for providing marketing, advertisement, and/or promotional, materials along with, or in conjunction with, account billing and/or account statement information which can identify the respective marketing materials or information, advertising materials or information, and/or promotional materials or information.

It is still another object of the present invention to provide an apparatus and method for providing marketing, advertisement, and/or promotional, materials along with, or in conjunction with, account billing and/or account statement information which can identify or select pre-selected or pre-requested marketing materials or information, advertising materials or information, and/or promotional materials or information.

It is yet another object of the present invention to provide an apparatus and method for providing marketing, advertisement, and/or promotional, materials along with, or in conjunction with, account billing and/or account statement information which can target or schedule the respective marketing materials or information, advertising materials or information, and/or promotional materials or information, for dissemination account holders or account owners.

It is another object of the present invention to provide an apparatus and method for providing marketing, advertisement, and/or promotional, materials along with, or in conjunction with, account billing and/or account statement information which can generate or produce the respective marketing materials or information, advertising materials or information, and/or promotional materials or information.

It is still another object of the present invention to provide an apparatus and method for providing marketing, advertisement, and/or promotional, materials along with, or in conjunction with, account billing and/or account statement information which can generate or produce the respective marketing materials or information, advertising materials or information, and/or promotional materials or information, in hard copy form.

It is yet another object of the present invention to provide an apparatus and method for providing marketing, advertisement, and/or promotional, materials along with, or in conjunction with, account billing and/or account statement information which can generate or produce the respective marketing materials or information, advertising materials or information, and/or promotional materials or information, in electronic form.

It is another object of the present invention to provide an apparatus and method for providing marketing, advertisement, and/or promotional, materials along with, or in conjunction with, account billing and/or account statement information which can process the respective materials or information for physical delivery or physical mail delivery to an account holder or an account owner.

It is still another object of the present invention to provide an apparatus and method for providing marketing, advertisement, and/or promotional, materials along with, or in conjunction with, account billing and/or account statement information which can process the respective materials or information for transmission to an account holder or an account owner.

It is yet another object of the present invention to provide an apparatus and method for providing marketing, advertisement, and/or promotional, materials along with, or in conjunction with, account billing and/or account statement information which can provide identification and/or tracking information on the respective materials or information for tracking the usage and/or effectiveness of same.

It is another object of the present invention to provide an apparatus and method for providing marketing, advertisement, and/or promotional, materials along with, or in conjunction with, account billing and/or account statement information which can process transactions involving any goods, products, services, information, and/or subscriptions, which are the subject of the respective materials or information.

It is still another object of the present invention to provide an apparatus and method for providing marketing, advertisement, and/or promotional, materials along with, or in conjunction with, account billing and/or account statement information which can process financial transactions, and/or effect electronic financial transfers, for any of the respective parties involved in a transaction.

It is another object of the present invention to provide an apparatus and method for providing marketing, advertisement, and/or promotional, materials along with, or in conjunction with, account billing and/or account statement information which can provide links or hyperlinks to merchants, providers, vendors, marketers, advertisers, and/or promoters.

It is still another object of the present invention to provide an apparatus and method for providing marketing, advertisement, and/or promotional, materials along with, or in conjunction with, account billing and/or account statement information which can provide links and/or hyperlinks to any information pertaining to any of the goods, products, services, information, magazines, periodicals, and/or other entities which are being featured in any of the respective materials.

It is yet another object of the present invention to provide an apparatus and method for providing marketing, advertisement, and/or promotional, materials along with, or in conjunction with, account billing and/or account statement information which can provide notification of the scheduled sending, transmission, and/or dissemination, and/or of the actual sending, transmission, and/or dissemination, of account bills, account correspondences, account billing correspondences, account billing statements, account statements, account statement correspondences, and account-related communications and/or correspondences, and the respective marketing materials or information, advertising materials or information, and/or promotional materials or information.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates a preferred embodiment method for utilizing the apparatus of FIG. 1, in flow diagram form; and

FIG. 4 illustrates another preferred embodiment method for utilizing the apparatus of FIG. 1, in flow diagram form.

### DESCRIPTION OF THE PREFERRED EMBODIMENTS

The present invention pertains to an apparatus and method for providing marketing, advertisement, and/or promotional, materials along with, or in conjunction with, account billing and/or account statement information and, in particular, to an apparatus and method for providing marketing, advertisement, and/or promotional, materials with account billing and/or account statement information for credit card accounts, credit accounts, debit accounts, bank accounts, checking accounts, electronic money accounts, utility accounts, services accounts, subscription accounts, and/or any other accounts involving providing correspondence to account holders.

The apparatus and method of the present invention can provide marketing, advertisement, and/or promotional, materials and/or information, along with and/or in conjunction with, account billing information, account bills, account billing correspondence, account statement information, account statements, and/or account statement correspondence. For example, the apparatus and method of the present invention can provide an marketing flier or an advertisement along with an account bill or an account billing statement or account statement. The apparatus and method of the present invention can provide marketing, advertisement, and/or promotional, materials and/or information, in hardcopy form, in electronic form, and/or in any combination of same.

The apparatus and method of the present invention can provide marketing, advertisement, and/or promotional, materials and/or information, which can be pre-selected for an account or account holder and/or which can be custom-tailored and/or custom-selected for a particular account or account holder based upon information regarding a particular account, a particular account holder, and/or a particular merchant, advertiser, promoter, and/or any provider of any goods, products, and/or services.

As used herein, the term “account” or the “accounts” refer to any accounts, subscription accounts, credit card accounts, debit card accounts, smart card accounts, bank accounts, savings accounts, checking accounts, automated teller machine accounts, electronic money accounts, digital cash accounts, brokerage accounts, commodities accounts, communication accounts, telephone accounts, telephone service accounts, communication accounts, wireless communication accounts, utility accounts, utility services accounts, electric service accounts, gas service accounts, Internet service accounts, Internet service provider accounts, subscription accounts for any goods, products, and/or services, which can be the subject of a subscription, a subscription account, and/or any other accounts.

As used herein, the terms “individual”, “user”, “account holder”, or “account owner”, or the plurals of same, refer to any individuals, users, accounts holders, account owners, and/or any agents and/or representatives of same, who or which can be provided with any of the herein-described marketing, advertisement, and/or promotional, materials and/or information, and/or who or which can otherwise utilize the apparatus and method of the present invention.

As used herein, the terms “operator”, “administrator”, or the plural of same, refer to any operator or administrator who or which operates and/or administers the operation of the apparatus of the present invention.

As used herein, the terms “merchant”, “provider”, “vendor”, “marketer”, “marketing entity”, “advertiser”, “advertising entity”, “promoter”, “promoting entity”, and/or the plural of same, refers to any merchant, provider, vendor, marketer, marketing individual or entity, advertiser, advertising individual or entity, promoter, and/or promoting individual or entity, who or which provides, or causes to be provided or disseminated, any of the herein-described marketing materials and/or information, advertisement materials and/or information, and/or promotional materials and/or information, and/or any of the goods, products and/or services which may be the subject any of the herein-described marketing, advertising, and/or promotional, materials and/or information.

Applicant hereby incorporates by reference herein the subject matter and teachings of U.S. Provisional Patent Application Serial No. 60/259,476 which teaches and discloses an apparatus and method for providing marketing, advertising, and/or promotional, materials with account billing and/or account statement information.

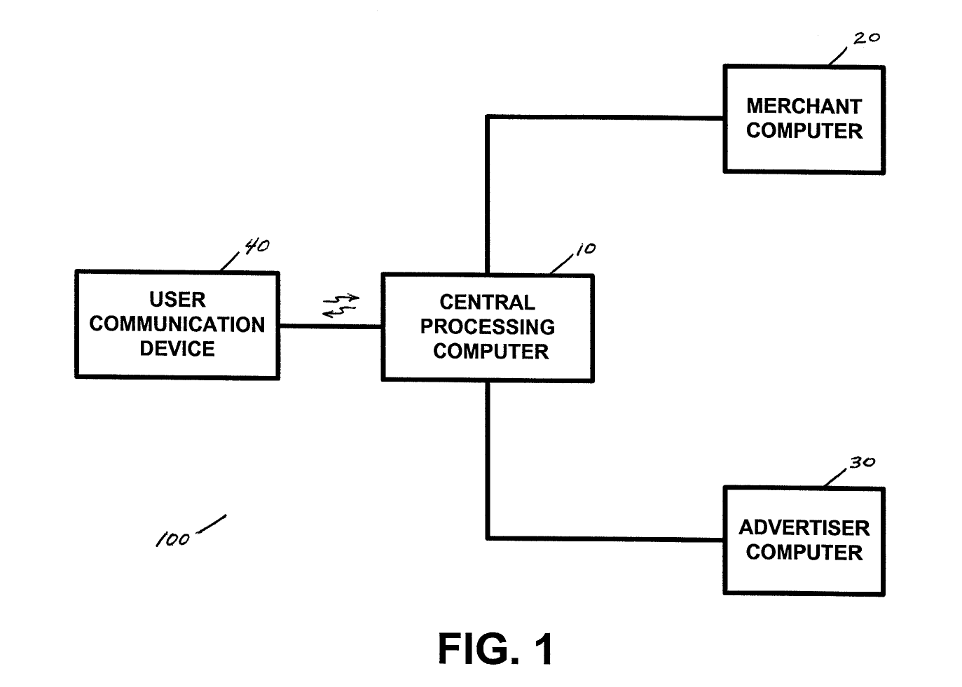

FIG. 1 illustrates a preferred embodiment of the apparatus of the present invention which is designated generally by the reference numeral 100, in block diagram form. With reference to FIG. 1, the apparatus 100 includes a central processing computer 10.

The central processing computer 10 can perform any of the herein-described processing routines and/or processing operations for providing marketing materials and/or information, advertising materials and/or information, or promotional materials and/or information, along with and/or in conjunction with account billing information or correspondence, or account statement information or correspondence. The central processing computer 10 can also provide any of the other information described herein as being provided by the apparatus 100 and/or perform any of the processing routines described herein as being performed by the apparatus 100.

The central processing computer 10 can be an account billing computer, an account statement generating computer, an account administration computer, an account management computer, and/or a separate computer or computer system which can be associated with, integrated with, connected with, and/or linked with, an account billing computer, an account statement generating computer, an account administration computer, an account management computer.

The central processing computer 10 can service any number of accounts, merchants, vendors, marketers, advertisers, promoters, and/or can be dedicated for servicing any one or more accounts, merchants, vendors, marketers, advertisers, promoters. The central processing computer 10 can include any number of central processing computers. Any number of central processing computers 10 can be utilized in conjunction with the apparatus 100.

The central processing computer 10 can be any computer, computer system, network computer, server computer, and/or communication device.

With reference once again to FIG. 1, the apparatus 100 can also include one of more merchant computers 20 which can be associated with can one or more of merchants, vendors, or providers, of any goods, products, or services, which can be the subject to commerce. The merchant computer 20 can transmit information to as well as receive information from the central processing computer(s) 10.

The merchant computer 20 can be any one or more a computer, a computer system, a group of computers, a telephone, a personal computer, a wireless telephone, a personal digital assistant, a video telephone, a personal communication device, a wireless device, a handheld device, a palm-top device, and/or any other communication device(s) and/or computer(s).

With reference once again to FIG. 1, the apparatus 100 can also include one of more advertiser computers 30 which can be associated with can one or more of merchants, vendors, or providers, of any goods, products, or services, advertisers, and/or promoters, who or which can provide and/or be responsible for providing and/or causing to be provided any of the marketing materials and/or information, advertising materials and/or information, and/or promotional materials and/or information, described herein. The advertiser computer 30 can transmit information to as well as receive information from the central processing computer(s) 10.

The advertiser computer 30 can be any one or more a computer, a computer system, a group of computers, a telephone, a personal computer, a wireless telephone, a personal digital assistant, a video telephone, a personal communication device, a wireless device, a handheld device, a palm-top device, and/or any other communication device(s) and/or computer(s).

With reference once again to FIG. 1, the apparatus 100 can also include one of more user communication device 40 which can be associated with can one or more of the herein-described users or individuals. The user communication device 40 can transmit information to as well as receive information from the central processing computer(s) 10.

The user communication device 40 can be any one or more a computer, a computer system, a group of computers, a telephone, a personal computer, a wireless telephone, a personal digital assistant, a video telephone, a personal communication device, a wireless device, a handheld device, a palm-top device, and/or any other communication device(s) and/or computer(s).

Any number of central processing computers 10, the merchant computers 20, advertiser computers 30, and/or user communication devices 40, can be utilized in conjunction with the present invention.

The central processing computers 10, the merchant computers 20, the advertiser computers 30, and/or the user communication devices 40, can communicate with, transmit information to, and/or receive information from, any other central processing computers 10, merchant computers 20, advertiser computers 30, and/or user communication devices 40, over any suitable communication network or system, including, but not limited to the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

The apparatus 100 can be utilized on, over, and/or in conjunction with, any suitable communication network or system, including, but not limited to the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

Each of the central processing computers 10, the merchant computers 20, the advertiser computers 30, and/or the user communication devices 40,, can include a central processing unit (CPU), a random access memory (RAM), a read only memory (ROM), an input device, a display device, a receiver, a transmitter, a database, and an output device.

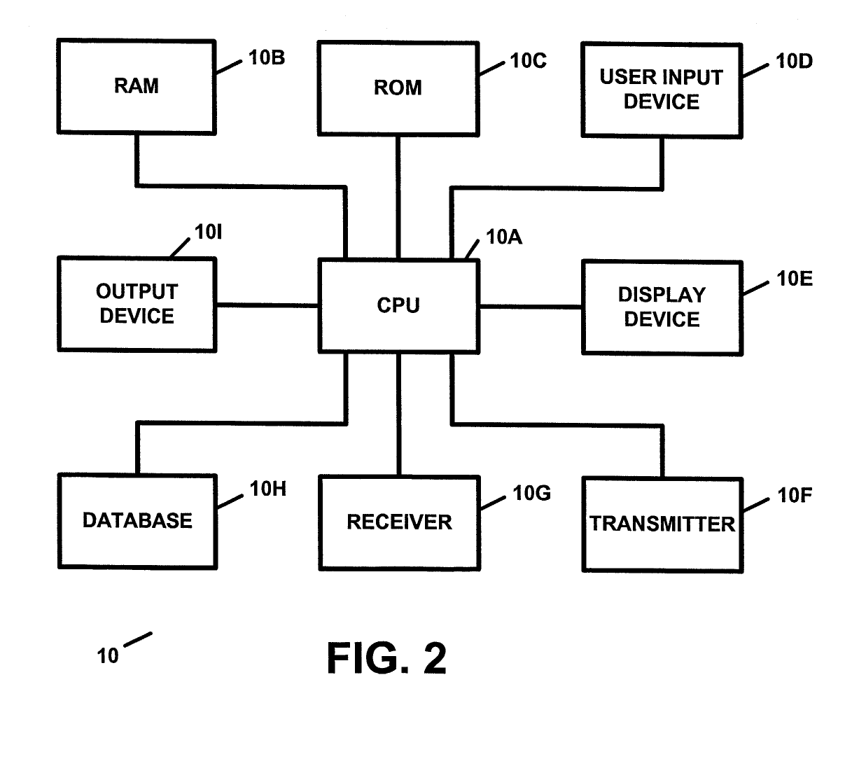

FIG. 2 illustrates the central processing computer 10 of FIG. 1, in block diagram form. With reference to FIG. 2, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computers 10, the merchant computers 20, the advertiser computers 30, and/or the user communication devices 40, which may be utilized in conjunction with the present invention.

The central processing computer 10 also includes a receiver 10G, for receiving signals and/or data and/or information from any one or more of the central processing computer(s) 10, the merchant computers 20, the advertiser computers 30, and/or the user communication devices 40, which may be utilized in conjunction with the present invention.

The central processing computer 10 also includes a database 10H. The database 10H can include any data and/or information needed and/or desired for performing any of the processing routines and/or functionality described herein as being performed by the central processing computer(s) 10 and/or by the apparatus 100.

The database 10H can also include any data and/or information needed and/or desired for performing any of the processing routines and/or functionality described herein as being performed by any of the merchant computers 20, the advertiser computers 30, and/or the user communication devices 40, described herein.

The database 10H can contain data and/or information regarding any of the account holders, account owners, and accounts, for any of the herein-described accounts, who or which are serviced by the apparatus 100. The database 10H can also contain account information, account number information, account identification information and any other pertinent or relevant account information.

The database 10H can also contain contact and/or correspondence information for any of the accounts, account holders, account owners, account administrators, and/or other individuals or entities described herein which can include, but which is not limited to, name(s), address or addresses, mailing address or mailing addresses, telephone number(s), facsimile number(s), e-mail address or e-mail addresses, uniform resource locator (url) or urls, contact information, and/or contact name(s).

The database 10H can also contain data and/or information needed, required, and/or desired, for generating any of the account bills, account correspondence, account billing correspondence, account billing statements, account statements, account statement correspondence, and/or any other account-related communication and/or correspondence. The database 10H can also contain data and/or information regarding any of the herein-described account bills, account correspondence, account billing correspondence, account billing statements, account statements, account statement correspondence, and/or any other account-related communication and/or correspondence.

The database 10H can also contain information regarding any of the users, individuals, account holders, and/or account owners, described herein including, but not limited to prior transactions, prior transactions on a particular account(s), prior transactions on other account(s), past buying, purchasing, and/or leasing, habits and/or histories, information regarding projected or future buying, purchasing, and/or leasing, activity, demographic information, spending habits of account holders or account owners, information regarding the correlation of account activity with other activities, statistical information regarding account activity, and/or any other data and/or information for facilitating the various processing routines and/or functionality described herein as being performed by the apparatus 100, the central processing computer 10, and/or any of the other computers or communication devices 20, 30, or 40, respectively, which are described herein.

The database 10H can also contain data and/or information regarding any parameters, characteristics, restrictions on account activity, and/or limitations on account activity, for any of the herein-described accounts. For example, information regarding credit limits can be stored for any credit card accounts, information regarding overdraft limits can be stored for checking accounts, debit accounts, electronic money accounts, banking accounts, etc., information regarding usage and spending limit restrictions can be stored for any of the accounts described herein, information regarding usage limitations can be stored for any of the accounts described herein, and/or information regarding expiration dates, cancellations of, and/or renewals for, any of the herein-described accounts, as well as subscription accounts, can also be stored.

The database 10H can also contain data and/or information regarding any of the merchants, vendors, advertisers, marketers, promoters, or agents or representatives of same, which can include, but which is not limited to, contact or correspondence information which can include name(s), address or addresses, mailing address or mailing addresses, telephone number(s), facsimile number(s), e-mail address or e-mail addresses, uniform resource locator (URL) or URLs, contact information, and/or contact name(s), and/or the respective goods, products, and/or services offered by, sold by, leased by, advertised by, marketed by, and/or promoted by, the respective merchants, vendors, advertisers, marketers, promoters, or agents or representatives of same.

The database 10H can also contain the respective marketing materials or information, advertising materials or information, promotional materials or information, which can be provided by or via the apparatus 100 of the present invention. The respective marketing materials or information, advertising materials or information, promotional materials or information, can contain and/or include text information, video information, video clips, audio information, audio clips, audio and video information, audio and video clips, and/or any combination of same. The respective marketing materials or information, advertising materials or information, promotional materials or information, can also include links to any of the herein-described merchants, vendors, marketers, advertiser, and/or promoters, described herein as being associated with the respective materials or information.

The database 10H can also contain data, information, software programs, and/or software algorithms, for generating and/or for producing any of the herein-described respective marketing materials or information, advertising materials or information, promotional materials or information. The database 10H can also contain data and/or information regarding criteria for providing any of the respective marketing materials or information, advertising materials or information, promotional materials or information, with any of the herein-described account bills, account correspondence, account billing correspondence, account billing statements, account statements, account statement correspondence, and/or any other account-related communication and/or correspondence.

The database 10H can also contain data and/or information for targeting, selecting, and/or scheduling, the dissemination of any of the respective marketing materials or information, advertising materials or information, promotional materials or information, with any of the herein-described account bills, account correspondence, account billing correspondence, account billing statements, account statements, account statement correspondence, and/or any other account-related communication and/or correspondence, to any of the herein-described users, individuals, account holders, and/or accounts owners.

The database 10H can also contain data and/or information regarding billing or statement closing dates or times and/or cycle closing dates or times, billing or statement generation, mailing, and/or dissemination, dates or times, interim billing information, dates, or times, and/or criteria or conditions for generating any of the herein-described account bills, account correspondence, account billing correspondence, account billing statements, account statements, account statement correspondence, and/or any other account-related communication and/or correspondence.

The database 10H can also contain data and/or information for correlating any of the herein-described marketing materials or information, advertising materials or information, and/or promotional materials or information, with any of the herein-described accounts, account bills, account correspondence, account billing correspondence, account billing statements, account statements, account statement correspondence, and/or any other account-related communication and/or correspondence.

The database 10H can also contain data and/or information for providing the physical delivery of, the physical mail delivery of, the e-mail delivery of, the electronic transmission of, and/or the instant messaging delivery of, any of the herein described marketing materials or information, advertising materials or information, and/or promotional materials or information, to any of the respective users, individuals, account holders, and/or account owners, described herein.

The database 10H can also contain data and/or information for managing and/or administering financial accounts for any of the herein-described users, individuals, account holders, account owners, account administrators, merchants, vendors, marketers, advertisers, and/or promoters, described herein as utilizing the apparatus 100 of the present invention. The database 10H can also contain data and/or information for processing financial transactions between any of the herein-described users, individuals, account holders, account owners, account administrators, merchants, vendors, marketers, advertisers, and/or promoters, described herein as utilizing the apparatus 100 of the present invention.

The database 10H can also contain data and/or information for performing monetary and/or financial transfers, electronically and/or otherwise, to and/or from any of the financial accounts associated with any of the herein-described users, individuals, account holders, account owners, account administrators, merchants, vendors, marketers, advertisers, and/or promoters, described herein as utilizing the apparatus 100 of the present invention.

Any of the data and/or information described herein can be provided from multiple information sources and/or from multiple individuals or entities by utilizing any of the respective central processing computers 10, merchant computers 20, advertiser computers 30, and/or user communication devices 40.

The database 10H can also contain any other information which may be relevant, pertinent, useful, and/or desired, for facilitating the operation of the apparatus and method of the present invention as described herein and/or as related thereto.

The database 10H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6^{th} Edition, Prentice Hall 1996.

The database 10H, or collection of databases, may be updated by each of the respective users, individuals, central processing computer operators or administrators, merchants, vendors, advertisers, promoters, described herein, and/or by any other individual, entity, or third party, in real-time and/or otherwise, and/or via dynamically linked database management techniques.

The data and/or information stored in the database 10H can also be updated by external sources. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The database 10H can also include any other data and/or information needed and/or desired for facilitating the functions and operation of the present invention as described herein.

With reference once again to FIG. 2, the central processing computer 10 also includes an output device 10I such as a printer, a modem, a fax/modem, or other output device, for generating any of the herein-described marketing materials or information, advertising materials or information, and/or promotional materials or information, described herein as being provided by the apparatus 100 and/or for providing information to the operator or user of the central processing computer 10 or to a third party or third party entity.

The apparatus and method of the present invention can be utilized in order to provide marketing materials or information, advertising materials or information, promotional materials or information, and/or offering materials or information, for or regarding any goods, products, services, information, subscriptions, and/or subscriptions for any of the above goods, products, services, and/or information, of any kind or type, along with and/or in conjunction with and/or with any of the herein-described account bills, account correspondence, account billing correspondence, account billing statements, account statements, account statement correspondence, and/or any other account-related communication and/or correspondence.

For example, the apparatus 100 and method of the present invention can provide advertising materials or a flier concerning an offering of a good or goods, a product or products, a service or services, and/or a subscription or subscriptions, along with, or in conjunction with, for example a credit card billing statement, a checking account statement, a utility bill, or any other account bill, statement and/or correspondence. The subscription offering information can pertain to an subscriptions of any regularly and/or otherwise provides goods, products, services, newspapers, newsletters, magazines, books, information sources of any kind, and/or any other entity or service which can be provided through a subscription.

The respective marketing materials or information, advertising materials or information, promotional materials or information, and/or offering materials or information, as well as the associated, corresponding, and/or underlying account bills, account correspondence, account billing correspondence, account billing statements, account statements, account statement correspondence, and/or any other account-related communication and/or correspondence, can be generated, produced and sent, transmitted, and/or disseminated in hard copy form, such as in the form of hardcopy printed bills, statements, communications, correspondence, marketing materials, advertisement materials, and/or promotional material, which can be sent via physical delivery, and/or can be generated, produced and sent, transmitted, and/or disseminated in electronic form, such as in the form of electronic bills, statements, communications, correspondence, marketing materials, advertisement materials, and/or promotional material, which can be sent via electronic transmission, facsimile transmission, electronic mail (e-mail) message transmission, instant messaging message transmission, and/or via any other electronic or digital transmission.

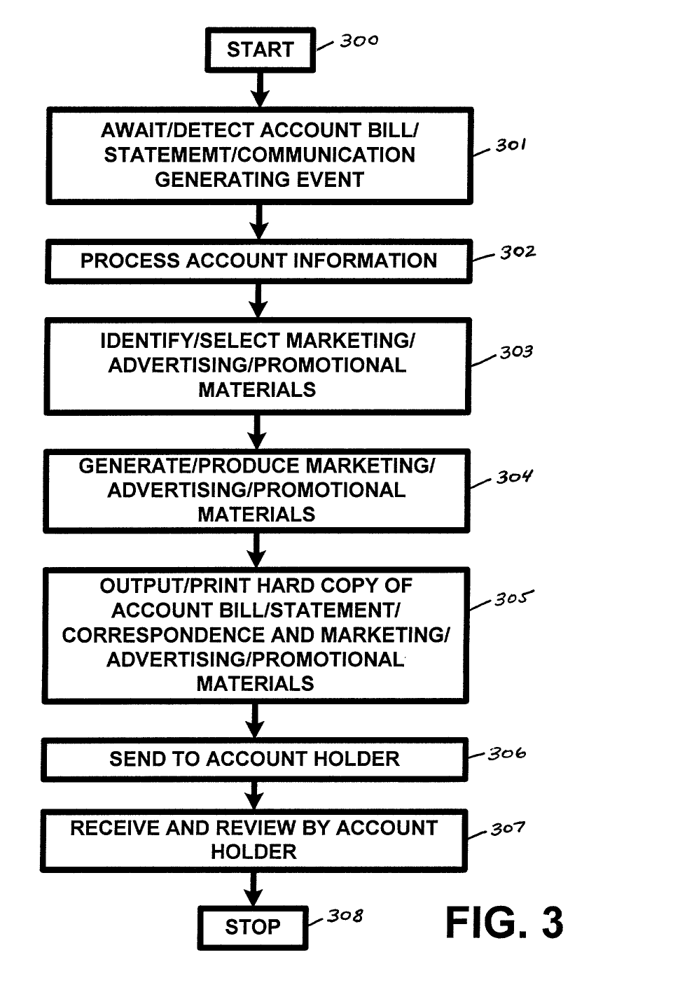

FIG. 3 illustrates a preferred embodiment method for utilizing the apparatus 100 of the present invention, in flow diagram form. In the embodiment of FIG. 3, the respective marketing materials or information, advertising materials or information, promotional materials or information, and/or offering materials or information, as well as the associated, corresponding, and/or underlying account bills, account correspondence, account billing correspondence, account billing statements, account statements, account statement correspondence, and/or any other account-related communication and/or correspondence, can be generated, produced and sent, transmitted, and/or disseminated in hard copy form.

With reference to FIG. 3, the operation of the apparatus 100 commences at step 300. At step 301, the central processing computer 10 will await and/or detect the generation of any one or more an account bill, an account correspondence, an account billing correspondence, an account billing statement, an account statement, an account statement correspondence, and/or any other account-related communication and/or correspondence, for a particular account. For example, the central processing computer 10 can detect when an account billing statement is being produced or generated for an particular account. This can, for example, be accomplished by a central processing computer 10 which is integrated with, which is an integral component of, and/or which is linked with, an account billing statement computer or other pertinent computer or computer system.

If the central processing computer 10 is utilized for generating or producing the respective account bill, account correspondence, account billing correspondence, account billing statement, account statement, account statement correspondence, and/or any other account-related communication and/or correspondence, then the central processing computer 10, at step 301, can also generate and/or produce the respective account bill, account correspondence, account billing correspondence, account billing statement, account statement, account statement correspondence, and/or any other account-related communication and/or correspondence, and either print same out in hard copy form and/or store same in electronic form.

At step 302, the central processing computer 10 will process information associated with or pertinent to the account for which the respective account bill, account correspondence, account billing correspondence, account billing statement, account statement, account statement correspondence, and/or any other account-related communication and/or correspondence, is being generated or produced. At step 302, the central processing computer 10 can also identify the account of interest.

At step 303, the central processing computer 10 can identify the respective marketing materials or information, advertising materials or information, and/or promotional materials or information, which are to be provided along with, or in conjunction with, the respective account bill, account correspondence, account billing correspondence, account billing statement, account statement, account statement correspondence, and/or any other account-related communication and/or correspondence, for the particular account.

The respective marketing materials or information, advertising materials or information, and/or promotional materials or information, can be stored in the database 10H of the central processing computer 10. The respective marketing materials or information, advertising materials or information, and/or promotional materials or information, which are to be provided along with, and/or in conjunction with, the respective account bill, account correspondence, account billing correspondence, account billing statement, account statement, account statement correspondence, and/or any other account-related communication and/or correspondence, can be pre-selected by any one or more of the administrator of operator of the apparatus 100 and/or the central processing computer, any of the respective merchants, vendors, marketers, advertisers, and/or promoters, described herein. The respective marketing materials or information, advertising materials or information, and/or promotional materials or information, can also be pre-selected by, and/or pre-requested by any of the users, individuals, account holders and/or account owners of the respective account or accounts.

For example, a particular merchant or provider of goods, products, and/or services, and/or a marketing agent, an advertising agent and/or a promoter associated with the merchant or provider, desirous of advertising an offering can request that marketing materials, advertising materials or promotional materials, be provide with, or in conjunction with, the respective account bill, account correspondence, account billing correspondence, account billing statement, account statement, account statement correspondence, and/or any other account-related communication and/or correspondence, for a particular account, a group of accounts, a type(s) of accounts, and/or for any account holder, account owner, group of account holders, or groups of account owners.

The request by any of the herein described merchants, providers, vendors, marketers, advertisers, and/or promoters, and/or any agents of same, can be received by and can be processed by the central processing computer 10, such as by being received from transmissions of communications transmitted from any of the respective merchant computers 20 or advertisers computers 30 associated with the requesting party or entity, and can be stored in the database 10H of the central processing computer 10.

The users, individuals, account holders and/or account owners of the respective account or accounts can also request to receive particular or certain marketing materials or information, advertising materials or information, and/or promotional materials or information. The request by any of the herein described users, individuals, account holders, and/or account owners, and/or any agents of same, can be received by and can be processed by the central processing computer 10, such as by being received from transmissions of communications transmitted from any of the respective user communication device 40 associated with the requesting party or entity, and can be stored in the database 10H of the central processing computer 10.

The respective marketing materials or information, advertising materials or information, and/or promotional materials or information, can also be selected by the central processing 10 by utilizing software routines, demographic information, spending habits of consumers, account holders, and/or account owners, past purchasing and/or leasing activities, and/or by utilizing any other data and/or information which can be utilized in order to manage, to administer, and/or to run or execute, marketing campaigns and/or activities, advertising campaigns and/or activities, and/or promotional campaigns and/or activities.

At step 303, the respective marketing materials or information, advertising materials or information, and/or promotional materials or information, can be scheduled for dissemination to certain users, individuals, account holders, and/or account owners (i.e. sent with each monthly billing statement, every other monthly billing statement, scheduled pursuant to certain parameters, etc.), targeted for dissemination to certain users, individuals, account holders, and/or account owners (i.e. sent to individuals with certain incomes, sent to individuals who have made certain purchases from a particular merchant, sent to individuals who have already made a purchase from the advertising merchant, sent to individuals who are current in their payments, sent pursuant to any other parameters, etc.), and/or otherwise disseminated upon the occurrence of certain events or the satisfaction of certain conditions or parameters (i.e. a sale of certain goods, products, services, and/or subscriptions, a clearance sale of certain goods, products, services, and/or subscriptions, an individual paying off all prior debt or becoming current on an account, etc.).

Any of the data and/or information, and/or software routines, programs or algorithms, for facilitating any of the herein-described functionality can be stored in the database 10H of the central processing computer 10 as well as in any of the respective databases of any of the herein-described merchant computers 20, advertiser computers 30, and/or user communication devices 40.

At step 303, the central processing computer 10 will identify the respective marketing materials or information, advertising materials or information, and/or promotional materials or information, which are to be provided with, or in conjunction with, the respective account bill, account correspondence, account billing correspondence, account billing statement, account statement, account statement correspondence, and/or any other account-related communication and/or correspondence.

At step 304, the central processing computer 10 will generate or produce the respective marketing materials or information, advertising materials or information, and/or promotional materials or information. At step 304, the central processing computer 10 can generate or produce the respective marketing materials or information, advertising materials or information, and/or promotional materials or information, in hard copy form, such as by printing the respective materials or information out on a printer, or in electronic form for storing same in the database 10H of the central processing computer 10 and for later transmission to a user, individual, account holder, or account owner.

At step 305, the respective account bill(s), account correspondence(s), account billing correspondence(s), account billing statement(s), account statement(s), account statement correspondence(s) and/or any other account-related communication(s) and/or correspondence(s), and the respective marketing materials or information, advertising materials or information, and/or promotional materials or information, which are to be provided with and/or in conjunction with the account bill(s), account correspondence(s), account billing correspondence(s), account billing statement(s), account statement(s), account statement correspondence(s), and/or any other account-related communication(s) and/or correspondence(s), can be printed out in hard copy form (if not done so previously, can be correlated by the central processing computer 10 or appropriate equipment or machines, and can be processed for physical delivery or physical mail delivery to the respective user(s), individual(s), account holder(s), and/or account owner(s).

At step 306, the respective account bill(s), account correspondence(s), account billing correspondence(s), account billing statement(s), account statement(s), account statement correspondence(s), and/or any other account-related communication(s) and/or correspondence(s), along with the respective marketing materials or information, advertising materials or information, and/or promotional materials or information, can be sent or transmitted, via physically delivery, to the respective user(s), individual(s), account holder(s), and/or account owner(s).

At step 307, the respective account bill(s), account correspondence(s), account billing correspondence(s), account billing statement(s), account statement(s), account statement correspondence(s), and/or any other account-related communication(s) and/or correspondence(s), along with the respective marketing materials or information, advertising materials or information, and/or promotional materials or information, can be can be physically received and reviewed by the respective user(s), individual(s), account holder(s), and/or account owner(s).

Thereafter, the operation of the apparatus 100 will cease at step 308.

In another preferred embodiment, the respective account bill(s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, can be provided with identification and/or tracking information for tracking the use and/or effectiveness of the respective marketing materials or information, advertising materials or information, and/or promotional materials or information.

The information regarding the use and/or effectiveness of the respective marketing materials or information, advertising materials or information, and/or promotional materials or information, can be stored in the database 10H for later use in selecting and/or using the respective marketing materials or information, advertising materials or information, and/or promotional materials or information.

In another preferred embodiment, the central processing computer 10 can process transactions involving orders for, and/or purchases and/or leases for, any of the goods, products, services, information, and/or subscriptions, which can be the subject of any of the respective marketing materials or information, advertising materials or information, and/or promotional materials or information.

The central processing computer 10 can also process financial transactions, and/or effect electronic financial transfers, including electronic funds transfers, for, on behalf of and/or for, any of the respective users, individuals, account holders, account owners, merchants, providers, vendors, marketers, advertisers, and/or promoters, and/or agents of same. For example, the central processing computer 10 can process a transaction and/or a financial transaction for facilitating a purchase by an account holder from a merchant.

The central processing computer 10 can also process a transaction and/or a financial transaction for facilitating a payment by a merchant to a marketer or advertiser such as in an agency relationship, a broker relationship, a finder's fee-based relationship, and/or an affiliated marketing relationship.

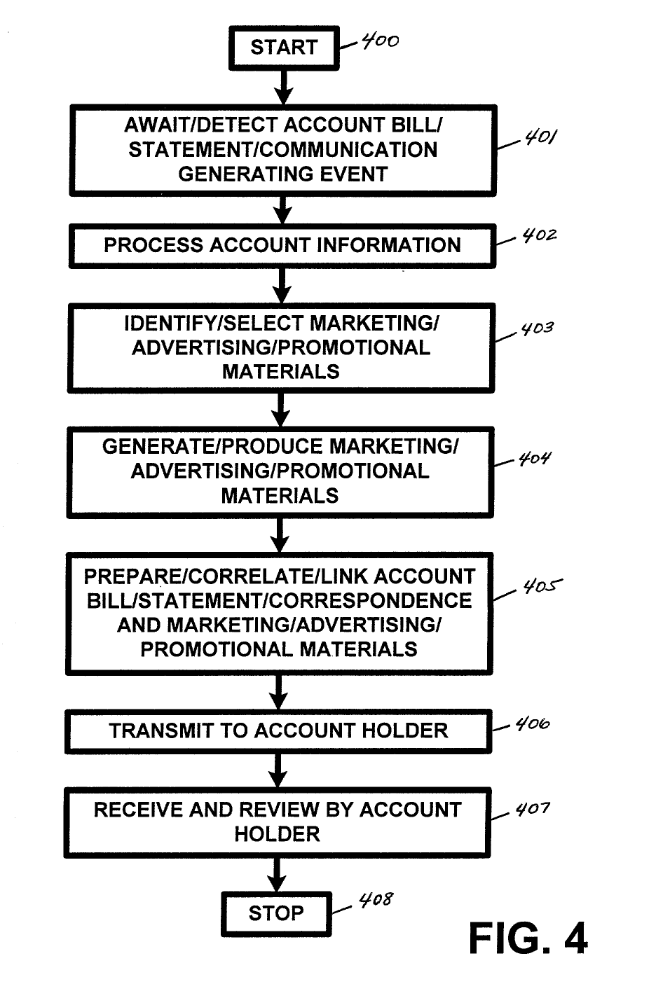

FIG. 4 illustrates a preferred embodiment method for utilizing the apparatus 100 of the present invention, in flow diagram form. In the embodiment of FIG. 4, the respective marketing materials or information, advertising materials or information, promotional materials or information, and/or offering materials or information, as well as the associated, corresponding, and/or underlying account bills, account correspondence, account billing correspondence, account billing statements, account statements, account statement correspondence, and/or any other account-related communication and/or correspondence, can be generated, produced and sent, transmitted, and/or disseminated in electronic form.

With reference to FIG. 4, the operation of the apparatus 100 commences at step 400. At step 401, the central processing computer 10 will await and/or detect the generation of any one or more an account bill, an account correspondence, an account billing correspondence, an account billing statement, an account statement, an account statement correspondence, and/or any other account-related communication and/or correspondence, for a particular account. For example, the central processing computer 10 can detect when an account billing statement is being produced or generated for an particular account. This can, for example, be accomplished by a central processing computer 10 which is integrated with, which is an integral component of, and/or which is linked with, an account billing statement computer or other pertinent computer or computer system.

If the central processing computer 10 is utilized for generating or producing the respective account bill, account correspondence, account billing correspondence, account billing statement, account statement, account statement correspondence, and/or any other account-related communication and/or correspondence, then the central processing computer 10, at step 401, can also generate and/or produce the respective account bill, account correspondence, account billing correspondence, account billing statement, account statement, account statement correspondence, and/or any other account-related communication and/or correspondence, store same in electronic form.

At step 402, the central processing computer 10 will process information associated with or pertinent to the account for which the respective account bill, account correspondence, account billing correspondence, account billing statement, account statement, account statement correspondence, and/or any other account-related communication and/or correspondence, is being generated or produced. At step 402, the central processing computer 10 can also identify the account of interest.

At step 403, the central processing computer 10 can identify the respective marketing materials or information, advertising materials or information, and/or promotional materials or information, which are to be provided along with, or in conjunction with, the respective account bill, account correspondence, account billing correspondence, account billing statement, account statement, account statement correspondence, and/or any other account-related communication and/or correspondence, for the particular account.

The respective marketing materials or information, advertising materials or information, and/or promotional materials or information, can be stored in the database 10H of the central processing computer 10. The respective marketing materials or information, advertising materials or information, and/or promotional materials or information, which are to be provided along with, and/or in conjunction with, the respective account bill, account correspondence, account billing correspondence, account billing statement, account statement, account statement correspondence, and/or any other account-related communication and/or correspondence, can be pre-selected by any one or more of the administrator of operator of the apparatus 100 and/or the central processing computer, any of the respective merchants, vendors, marketers, advertisers, and/or promoters, described herein. The respective marketing materials or information, advertising materials or information, and/or promotional materials or information, can also be pre-selected by, and/or pre-requested by any of the users, individuals, account holders and/or account owners of the respective account or accounts.

For example, a particular merchant or provider of goods, products, and/or services, and/or a marketing agent, an advertising agent and/or a promoter associated with the merchant or provider, desirous of advertising an offering can request that marketing materials, advertising materials or promotional materials, be provide with, or in conjunction with, the respective account bill, account correspondence, account billing correspondence, account billing statement, account statement, account statement correspondence, and/or any other account-related communication and/or correspondence, for a particular account, a group of accounts, a type(s) of accounts, and/or for any account holder, account owner, group of account holders, or groups of account owners.

The request by any of the herein described merchants, providers, vendors, marketers, advertisers, and/or promoters, and/or any agents of same, can be received by and can be processed by the central processing computer 10, such as by being received from transmissions of communications transmitted from any of the respective merchant computers 20 or advertisers computers 30 associated with the requesting party or entity, and can be stored in the database 10H of the central processing computer 10.

The users, individuals, account holders and/or account owners of the respective account or accounts can also request to receive particular or certain marketing materials or information, advertising materials or information, and/or promotional materials or information. The request by any of the herein described users, individuals, account holders, and/or account owners, and/or any agents of same, can be received by and can be processed by the central processing computer 10, such as by being received from transmissions of communications transmitted from any of the respective user communication device 40 associated with the requesting party or entity, and can be stored in the database 10H of the central processing computer 10.

The respective marketing materials or information, advertising materials or information, and/or promotional materials or information, can also be selected by the central processing 10 by utilizing software routines, demographic information, spending habits of consumers, account holders, and/or account owners, past purchasing and/or leasing activities, and/or by utilizing any other data and/or information which can be utilized in order to manage, to administer, and/or to run or execute, marketing campaigns and/or activities, advertising campaigns and/or activities, and/or promotional campaigns and/or activities.

At step 403, the respective marketing materials or information, advertising materials or information, and/or promotional materials or information, can be scheduled for dissemination to certain users, individuals, account holders, and/or account owners (i.e. sent with each monthly billing statement, every other monthly billing statement, scheduled pursuant to certain parameters, etc.), targeted for dissemination to certain users, individuals, account holders, and/or account owners (i.e. sent to individuals with certain incomes, sent to individuals who have made certain purchases from a particular merchant, sent to individuals who have already made a purchase from the advertising merchant, sent to individuals who are current in their payments, sent pursuant to any other parameters, etc.), and/or otherwise disseminated upon the occurrence of certain events or the satisfaction of certain conditions or parameters (i.e. a sale of certain goods, products, services, and/or subscriptions, a clearance sale of certain goods, products, services, and/or subscriptions, an individual paying off all prior debt or becoming current on an account, etc.).

Any of the data and/or information, and/or software routines, programs or algorithms, for facilitating any of the herein-described functionality can be stored in the database 10H of the central processing computer 10 as well as in any of the respective databases of any of the herein-described merchant computers 20, advertiser computers 30, and/or user communication devices 40.

At step 403, the central processing computer 10 will identify the respective marketing materials or information, advertising materials or information, and/or promotional materials or information, which are to be provided with, or in conjunction with, the respective account bill, account correspondence, account billing correspondence, account billing statement, account statement, account statement correspondence, and/or any other account-related communication and/or correspondence.

At step 404, the central processing computer 10 will generate or produce the respective marketing materials or information, advertising materials or information, and/or promotional materials or information. At step 304, the central processing computer 10 can generate or produce the respective marketing materials or information, advertising materials or information, and/or promotional materials or information, in electronic form and storing same in the database 10H of the central processing computer

The respective marketing materials or information, advertising materials or information, and/or promotional materials or information, can contain links or hyperlinks to any of the merchants, providers, vendors, marketers, advertisers, and/or promoters, and/or can contain links and/or hyperlinks to any information pertaining to any of the goods, products, services, information, magazines, periodicals, and/or other entities which are being featured in, and/or which are being marketed, advertised, and/or promoted, in or by the respective marketing materials or information, advertising materials or information, and/or promotional materials or information.

At step 405, the respective account bill(s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, which are to be provided with and/or in conjunction with the account bill(s), account correspondence(s), account billing correspondence(s), account billing statement(s), account statement(s), account statement correspondence(s), and/or any other account-related communication(s) and/or correspondence(s), can be correlated or linked together by the central processing computer 10, and can be processed for electronic delivery to the respective user(s), individual(s), account holder(s), and/or account owner(s).

The respective account bill(s), account correspondence(s), account billing correspondence(s), account billing statement(s), account statement(s), account statement correspondence(s), and/or any other account-related communication(s) and/or correspondence(s), and the respective marketing materials or information, advertising materials or information, and/or promotional materials or information, can be generated as any one or more of e-mail messages, instant messaging messages, facsimile messages, electronic messages and/or electronic transmission messages.

At step 406, the respective account bill(s), account correspondence(s), account billing correspondence(s), account billing statement(s), account statement(s), account statement correspondence(s), and/or any other account-related communication(s) and/or correspondence(s), along with the respective marketing materials or information, advertising materials or information, and/or promotional materials or information, can be transmitted to the respective user(s), individual(s), account holder(s), and/or account owner(s), to the user communication device(s) 40 associated with the respective user(s), individual(s), account holder(s), and/or account owner(s), or to any communication storage facility or e-mail server computer servicing any of the respective user(s), individual(s), account holder(s), and/or account owner(s).

At step 407, the respective account bill(s), account correspondence(s), account billing correspondence(s), account billing statement(s), account statement(s), account statement correspondence(s), and/or any other account-related communication(s) and/or correspondence(s), along with the respective marketing materials or information, advertising materials or information, and/or promotional materials or information, can be can be received and reviewed by the respective user(s), individual(s), account holder(s), and/or account owner(s).

At step 407, the user, individual, account holder, and/or account owner, can link to any of the information provided in or contained in the respective marketing materials or information, advertising materials or information, and/or promotional materials or information. The information can include any one or more of, and/or any combination of, text material, audio material, audio clips, video material, video clips, audio and video material, and/or audio and video clips.

At step 407, the user, individual, account holder, and/or account owner, can enter into transactions involving any of the goods, products, services, information, and/or subscriptions which are offered by and/or featured in the respective marketing materials or information, advertising materials or information, and/or promotional materials or information.

Thereafter, the operation of the apparatus 100 will cease at step 408.

In another preferred embodiment, the respective account bill(s), account correspondence(s), account billing correspondence(s), account billing statement(s), account statement(s) account statement correspondence(s), and/or any other account-related communication(s) and/or correspondence(s), and the respective marketing materials or information, advertising materials or information, and/or promotional materials or information, can be provided with identification and/or tracking information for tracking the use and/or effectiveness of the respective marketing materials or information, advertising materials or information, and/or promotional materials or information.

The information regarding the use and/or effectiveness of the respective marketing materials or information, advertising materials or information, and/or promotional materials or information, can be stored in the database 10H for later use in selecting and/or using the respective marketing materials or information, advertising materials or information, and/or promotional materials or information.

In another preferred embodiment, the central processing computer 10 can process transactions involving orders for, and/or purchases and/or leases for, any of the goods, products, services, information, and/or subscriptions, which can be the subject of any of the respective marketing materials or information, advertising materials or information, and/or promotional materials or information.

The central processing computer 10 can also process financial transactions, and/or effect electronic financial transfers, including electronic funds transfers, for, on behalf of and/or for, any of the respective users, individuals, account holders, account owners, merchants, providers, vendors, marketers, advertisers, and/or promoters, and/or agents of same. For example, the central processing computer 10 can process a transaction and/or a financial transaction for facilitating a purchase by an account holder from a merchant. The central processing computer 10 can also process a transaction and/or a financial transaction for facilitating a payment by a merchant to a marketer or advertiser such as in an agency relationship, a broker relationship, a finder's fee-based relationship, and/or an affiliated marketing relationship.

The apparatus and method of the present invention can be utilized in order to market, advertise, promote, sell or lease, any goods, products, services, information, magazines, periodicals, newspapers, newsletters, which can be the subject of commerce and/or of a transaction, and/or can be utilized in order to market, advertise, promote, sell or lease, subscriptions for any of the above-described goods, products, services, information, magazines, periodicals, newspapers, newsletters.

In another preferred embodiment, the central processing computer 10 can also provide notification of the scheduled sending, transmission, and/or dissemination, and/or of the actual sending, transmission, and/or dissemination, of any of the herein-described account bills, account correspondences, account billing correspondences, account billing statements, account statements, account statement correspondences, and/or any other account-related communications and/or correspondences, and the respective marketing materials or information, advertising materials or information, and/or promotional materials or information.

The present invention can also be utilized in order to disseminate sales or clearance offerings for any of the herein-described goods, products, services, information, magazines, periodicals, newspapers, newsletters, and/or subscriptions for any of the above-described goods, products, services, information, magazines, periodicals, newspapers, newsletters.

The apparatus and method of the present invention can be utilized in order to facilitate repeat transactions between any of the herein-described users, individuals, account holders, accounts owners, merchants, providers and vendors. For example, a merchant, having sold a good, product, or service, to an credit card account holder can send advertisements to the account holder with the account holder's credit card bill, thereby facilitating continued transactions and/or repeat business transactions between the account holder and the merchant. The present invention can also be utilized in order to build customer loyalty.

The apparatus and method of the present invention can also be utilized to develop branding of goods, products, and services, as well as co-branding relationships between respective parties or entities.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for providing marketing, advertising, or promotional, materials or information along with an account bill, an account billing statement, an account statement, or an account correspondence, comprising:
a memory device for storing at least one of account information, account billing information, account statement information, marketing information, advertising information, and promotional information;
a processor for detecting the generation of at least one of an account bill, an account billing statement, an account statement, and an account correspondence, wherein the processor at least one of identifies and selects at least one of marketing materials, advertising materials, and promotional materials, to be provided with the at least one of an account bill, an account billing statement, an account statement, and an account correspondence, and further wherein the processor generates the at least one of marketing materials, advertising materials, and promotional materials; and
an output device for outputting the at least one of marketing materials, advertising materials, and promotional materials.

2. The apparatus of claim 1, wherein the at least one of marketing materials, advertising materials, and promotional materials, contains information regarding at least one of a good, a product, a service, information, and a subscription for at least one of a good, a product, a service, information, a magazine, a newspaper, and a periodical.

3. The apparatus of claim 1, wherein the processor generates the at least one of an account bill, an account billing statement, an account statement, and an account correspondence, and further wherein the output device outputs the at least one of an account bill, an account billing statement, an account statement, and an account correspondence.

4. The apparatus of claim 1, wherein the account is at least one of a credit card account, a credit account, a debit account, a bank account, a checking account, an electronic money account, a utility account, an electricity account, a gas account, a telephone account, a telephone calling card account, a services account, and a subscription account.

5. The apparatus of claim 1, wherein the processor at least one of identifies and selects the at least one of marketing materials, advertising materials, and promotional materials, from at least one of merchant selected information, advertiser selected information, and account holder request information.

6. The apparatus of claim 1, wherein the output device is a printer.

7. The apparatus of claim 1, further comprising:
a receiver for receiving at least one of the at least one of marketing materials, advertising materials, and promotional materials, merchant instructions for disseminating the at least one of marketing materials, advertising materials, and promotional materials, advertiser instructions for disseminating the at least one of marketing materials, advertising materials, and promotional materials, and account holder requests to receive the at least one marketing materials, advertising materials, and promotional materials.

8. The apparatus of claim 1, wherein the apparatus is at least one of a computer, a computer system, a network computer, and a server computer.

9. An apparatus for providing marketing, advertising, or promotional, materials or information along with an account bill, an account billing statement, an account statement, or an account correspondence, comprising:
a memory device for storing at least one of account information, account billing information, account statement information, marketing information, advertising information, and promotional information;
a processor for detecting the generation of at least one of an account bill, an account billing statement, an account statement, and an account correspondence, wherein the processor at least one of identifies and selects at least one of marketing materials, advertising materials, and promotional materials, to be provided with the at least one of an account bill, an account billing statement, an account statement, and an account correspondence, and further wherein the processor generates the at least one of marketing materials, advertising materials, and promotional materials; and
a transmitter for transmitting the at least one marketing materials, advertising materials, and promotional materials, to a communication device associated with an account holder.

10. The apparatus of claim 9, wherein the processor generates the at least one of marketing materials, advertising materials, and promotional materials, as at least one of an e-mail message, an instant messaging message, an electronic message, and a facsimile message.

11. The apparatus of claim 9, wherein the at least one of marketing materials, advertising materials, and promotional materials, contains at least one of a link and a hyperlink to at least one of a merchant, a vendor, an advertiser, and information regarding at least one of a good, a product, a service, information, and a subscription.

12. The apparatus of claim 9, wherein the at least one of marketing materials, advertising materials, and promotional materials, contains information regarding at least one of a good, a product, a service, information, and a subscription for at least one of a good, a product, a service, information, a magazine, a newspaper, and a periodical.

13. The apparatus of claim 9, wherein the processor generates the at least one of an account bill, an account billing statement, an account statement, and an account correspondence.

14. The apparatus of claim 9, wherein the account is at least one of a credit card account, a credit account, a debit account, a bank account, a checking account, an electronic money account, a utility account, an electricity account, a gas account, a telephone account, a telephone calling card account, a services account, and a subscription account.

15. The apparatus of claim 9, wherein the processor at least one of identifies and selects the at least one of marketing materials, advertising materials, and promotional materials, from merchant selected information, advertiser selected information, and account holder requested information.

16. The apparatus of claim 9, further comprising:
a receiver for receiving at least one of the at least one of marketing materials, advertising materials, and promotional materials, merchant instructions for disseminating the at least one of marketing materials, advertising materials, and promotional materials, advertiser instructions for disseminating the at least one of marketing materials, advertising materials, and promotional materials, and account holder requests to receive the at least one marketing materials, advertising materials, and promotional materials.

17. A method for providing marketing, advertising, or promotional, materials or information along with an account bill, an account billing statement, an account statement, or an account correspondence, comprising:
storing at least one of account information, account billing information, account statement information, marketing information, advertising information, and promotional information;
detecting the generation of at least one of an account bill, an account billing statement, an account statement, and an account correspondence;
at least one of identifying and selecting at least one of marketing materials, advertising materials, and promotional materials, to be provided with the at least one of an account bill, an account billing statement, an account statement, and an account correspondence;
generating the at least one of marketing materials, advertising materials, and promotional materials; and
at least one of outputting the at least one of marketing materials, advertising materials, and promotional materials, and transmitting the at least one marketing materials, advertising materials, and promotional materials, to a communication device associated with an account holder.

18. The method of claim 17, further comprising:
generating the at least one of marketing materials, advertising materials, and promotional materials, as at least one of an e-mail message, an instant messaging message, an electronic message, and a facsimile message.

19. The method of claim 17, further comprising:
generating the at least one of an account bill, an account billing statement, an account statement, and an account correspondence; and
at least one of outputting and transmitting the at least one of an account bill, an account billing statement, an account statement, and an account correspondence.

20. The method of claim 17, wherein the at least one of marketing materials, advertising materials, and promotional materials, contains at least one of at least one of a link and a hyperlink to at least one of a merchant, a vendor, an advertiser, and information regarding at least one of a good, a product, a service, information, and a subscription, and information regarding at least one of a good, a product, a service, information, and a subscription for at least one of a good, a product, a service, information, a magazine, a newspaper, and a periodical, and further wherein the account is at least one of a credit card account, a credit account, a debit account, a bank account, a checking account, an electronic money accounts, a utility account, an electricity account, a gas account, a telephone account, a telephone calling card account, a services account, and a subscription account.
